(19) United States
(12) Patent Application Publication
(10) Pub. No.: US 2016/0318519 A1
(43) Pub. Date: Nov. 3, 2016

(54) CONTROL DEVICE FOR HYBRID VEHICLE

(71) Applicant: TOYOTA JIDOSHA KABUSHIKI KAISHA, Toyota-shi (JP)

(72) Inventors: Takuya HIRAI, Susono-shi (JP); Yuichi SHIMASAKI, Mishima-shi (JP); Rentaro KUROKI, Susono-shi (JP)

(73) Assignee: TOYOTA JIDOSHA KABUSHIKI KAISHA, Toyota-shi (JP)

(21) Appl. No.: 15/105,019

(22) PCT Filed: Dec. 15, 2014
(86) PCT No.: PCT/IB2014/002770

§ 371 Date: Jun. 16, 2016

(30) Foreign Application Priority Data
Dec. 18, 2013 (JP) 2013-261076

(51) Int. Cl. B60W 30/192; F02N 11/08; F02D 41/06; B60W 20/00

(52) U.S. Cl. CPC B60W 30/192; B60W 20/00; F02N 11/08; F02D 41/062; B60W 2710/06; F02N 2300/10

(57) ABSTRACT

A belt tension control device is mounted on a hybrid vehicle that is provided with an engine, a motor, a belt transmitting power between the engine and the motor, and tension changing means capable of changing tension applied to the belt. The belt tension control device is provided with control means for estimating a combustion torque relating to ignition start-up or a motor torque relating to the motor which is required to start the engine before the engine start-up and controlling the tension changing means to change the tension applied to the belt, based on the estimated motor torque before the engine is started, according to the estimated combustion torque so that torque to be transmitted to the engine from the motor is transmitted via the belt.

### BACKGROUND OF THE INVENTION

1. Field of the Invention

The invention relates to a control device for a hybrid vehicle that controls tension that is applied to a belt which transmits power between an engine, a motor, and auxiliary machines.

2. Description of Related Art

As an example of this type of devices, a device that incontractably locks a telescopic tensioner according to tension of a belt connecting a crankshaft of an engine and a starter motor before driving of the starter motor when the engine is re-started has been proposed (refer to Japanese Patent Application Publication No. 2003-314638 (JP 2003-314638 A)).

Also, a technique for adjusting a stop position of a crankshaft within a target range during engine stop by adjusting a short-circuit current flowing in an armature coil of a magnet generator according to a rotation angle position of the crankshaft and controlling a braking torque generated in a rotor of the magnet generator has been proposed (refer to Japanese Patent Application Publication No. 2001-193540 (JP 2001-193540 A)). In addition, a technique for starting an engine by using an explosion torque generated by ignition start-up and an electric motor torque of an electric motor during hybrid vehicle engine start-up has been proposed (refer to Japanese Patent Application Publication No. 2013-043572 (JP 2013-043572 A)).

As this type of devices, a device that more increases tension of a power transmission belt in a case where a rotating electrical machine starts an engine than in a case where the rotating electrical machine is driven by the engine in a vehicle in which the engine and the rotating electrical machine capable of starting the engine are connected to each other via the power transmission belt has been proposed (refer to Japanese Patent Application Publication No. 2004-011552 (JP 2004-011552 A)).

Also, a device that detects driving torques of a plurality of auxiliary machines and sets tension of a belt to maximize power transmission efficiency of the belt in a vehicle in which an engine and the plurality of auxiliary machines are connected to each other via the single belt has been proposed (refer to Japanese Patent Application Publication No. 57-161344 (JP 57-161344 A)).

### SUMMARY OF THE INVENTION

Methods for starting an engine include not only a method for starting the engine by igniting a fuel after cranking by a motor or the like (hereinafter, referred to as “motor-based start-up” as appropriate) but also a method for starting an engine by a combustion torque caused by explosion energy which is generated through ignition of a fuel injected into a cylinder of the engine in an expansion stroke (hereinafter, referred to as “ignition start-up” as appropriate).

In a vehicle in which an engine and a motor are connected via a belt and both the motor-based start-up and the ignition start-up are available, a combustion torque during the ignition start-up changes and a required motor torque also changes depending on, for example, a situation prior to engine start-up. Then, a technical problem may arise when a tensioner is incontractably locked during engine start-up to excessively increase the tension applied to the belt, increase friction attributable to the tension, deteriorate fuel economy, and make it difficult to start the engine as with a technique described in JP 2003-314638 A. In addition, it is difficult to address the above-described problem with the techniques described in JP 2001-193540 A, JP 2013-043572 A, JP 2004-011552 A, and JP 57-161344 A.

The invention provides a control device for a hybrid vehicle that is capable of appropriately setting tension that is applied to a belt during engine start-up in a vehicle in which an engine and a motor are connected to each other via a belt.

According to an aspect of the invention, there is provided a control device for a hybrid vehicle, the hybrid vehicle including an engine, a motor, a belt transmitting power between the engine and the motor, and a tension changing device (tension changing means) changing tension applied to the belt, and the hybrid vehicle being configured to start the engine through ignition of the engine and start the engine by the motor, the control device including: an electronic control unit (control means) configured to estimate a combustion torque relating to the ignition of the engine and a motor torque relating to the motor before the engine is started, and the electronic control unit being configured to change the tension applied to the belt based on the estimated motor torque before the engine is started such that a torque to be transmitted to the engine from the motor is transmitted via the belt according to the estimated combustion torque.

According to the control device of the invention, the hybrid vehicle on which the belt tension control device is mounted has the engine and the motor connected to each other via the belt and is provided with the tension changing means capable of changing the tension applied to the belt, an example of the tension changing means being a tensioner.

Herein, the “motor” according to the invention is not limited to a dedicated motor cranking the engine such as a starter motor, and may be a motor realized in a motor generator (electric motor generator). In other words, the “motor” according to the invention may mean a motor generator insofar as a function as the motor is provided.

Herein, particularly, the engine is configured to be cranked and started by the combustion torque that is generated through ignition of a fuel which is injected to a cylinder of the engine in an expansion stroke and the motor torque that is output from the motor as necessary in the hybrid vehicle on which the control device according to the invention is mounted. Accordingly, the engine is started by compensating for a combustion torque shortfall with the motor torque in a case where the combustion torque is not sufficient. In a case where the combustion torque is sufficient, the engine is started by the combustion torque alone (that is, ignition start-up).

In addition to the above-described method, the engine may be started by the motor alone (that is, engine start-up through the ignition of the fuel after the cranking by the motor).

Herein, the followings have been found according to research by the inventor of the present invention. The tension of the belt is relatively large, from the viewpoints of belt slip and power transmission, in a case where the motor torque is used in the cranking of the engine. In a case where the motor torque is not required for the cranking of the engine (that is, in the case of the ignition start-up of the engine), the belt is unlikely to slip and the tension of the belt is relatively small from the viewpoint of friction reduction. However, the combustion torque changes due to, for example, an oil/water temperature, an atmospheric pressure, and engine stop duration.

In the invention, the combustion torque relating to the ignition start-up and the motor torque relating to the motor are estimated, before the engine is started, by the control means provided with, for example, a memory processor and the like. In other words, the control means estimates the combustion torque that is obtained in a case where the ignition start-up is attempted and the motor torque relating to the motor such as torque which can be output from the motor.

Various known aspects can be applied to a method for estimating the combustion torque and the motor torque, and thus detailed description thereof will be omitted herein.

In the aspect of the invention, the electronic control unit (control means) may change the tension applied to the belt based on the estimated motor torque before the engine is started in a case where the estimated combustion torque is smaller than a torque required to start the engine such that a sum of the estimated combustion torque and the torque transmitted to the engine from the motor via the belt is equal to or larger than the required torque.

Specifically, the control means controls the tension changing means so that the tension of the belt is relatively small because no torque or little torque has to be transmitted to the engine from the motor in order to start the engine in a case where, for example, the estimated combustion torque is equal to or larger than the torque required to start the engine. In a case where the estimated combustion torque does not reach the torque required to start the engine, the control means controls the tension changing means to change the tension applied to the belt according to the estimated motor torque, so that the sum of the estimated combustion torque and the torque transmitted to the engine from the motor is equal to or larger than the torque required to start the engine (that is, the torque that compensates for the combustion torque is transmitted to the engine from the motor).

Therefore, the tension applied to the belt can be appropriately set according to the control device of the invention. As a result, the friction during the engine start-up can be appropriately reduced, and fuel economy can be improved.

Also, applying of an excessive tension to the belt can be prevented and, for example, shortening of the life of the belt can be suppressed. In addition, the width of the belt or the like does not have to be increased for resistance to the excessive tension.

In the aspect of the invention, the electronic control unit may control the tension changing device before the engine is started such that the tension applied to the belt when the estimated combustion torque is larger than a torque required to start the engine is smaller than the tension applied to the belt when the estimated combustion torque is smaller than the torque required to start the engine.

According to this aspect, the tension applied to the belt can be appropriately set and the engine can be started with relative ease even in a case where the estimated combustion torque is smaller than the torque required to start the engine, that is, even in a case where the engine cannot be started through the ignition start-up alone.

In the aspect of the control device of the invention, the control means controls the tension changing means before the engine is started, so that the tension applied to the belt is smaller than in a case where the estimated combustion torque is smaller than the torque required to start the engine, in a case where the estimated combustion torque is larger than the torque required to start the engine.

According to this aspect, the friction during the start-up of the engine can be reduced with relative ease, and the applying of the excessive tension to the belt can be prevented.

Effects and other advantages of the invention will be apparent from the embodiment described below.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a conceptual diagram illustrating a main portion of an engine according to an embodiment;

FIG. 2 is an example of time-dependent change in belt tension during engine start-up;

FIG. 3 is an example of time-dependent change in engine speed and crank angle during engine stop;

FIG. 4 is a conceptual diagram illustrating a concept of crank stop position control during engine stop;

FIG. 5 is a diagram illustrating the time-dependent change in belt tension according to the embodiment along with the time-dependent change in engine speed and crank angle; and

FIG. 6 is a diagram illustrating time-dependent change in belt tension according to a modification example of the embodiment along with time-dependent change in engine speed and crank angle.

### DETAILED DESCRIPTION OF EMBODIMENTS

An embodiment of a belt tension control device according to the invention will be described with reference to the accompanying drawings.

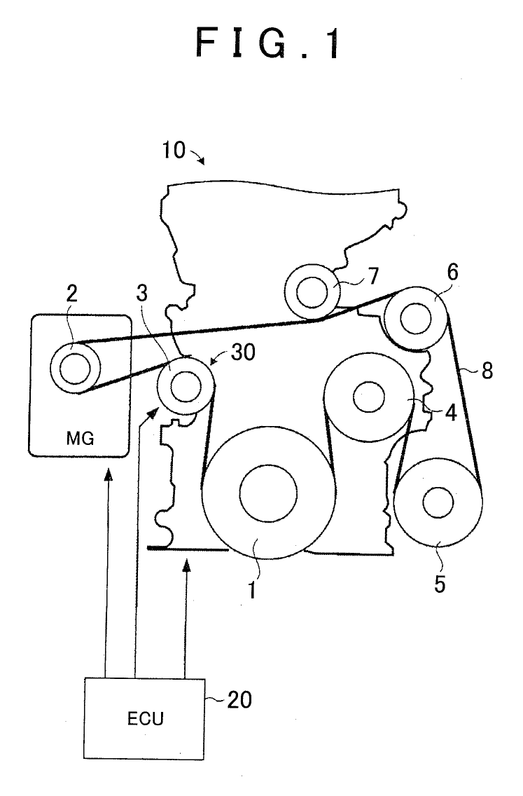

Firstly, a main portion of a mechanical configuration relating to the embodiment will be described with reference to FIG. 1. FIG. 1 is a conceptual diagram illustrating a main portion of an engine according to the embodiment.

In FIG. 1, a hybrid vehicle (not illustrated) is provided with an engine 10, a motor generator MG, and an electronic control unit (ECU) 20 that controls the engine 10, the motor generator MG, and the like.

A crank pulley 1 is fixed to a crankshaft of the engine 10. A motor generator pulley 2 is fixed to a rotating shaft of the motor generator MG. In general, the motor generator MG is a motor generator for controlling the engine 10 and generating electric power. However, the motor generator MG may be a motor generator for hybrid vehicle driving and a regeneration brake.

A belt 8 that transmits power is wound around the crank pulley 1, a water pump pulley 4 that is fixed to a rotating shaft of a water pump, an air-conditioning compressor pulley 5 that is fixed to a rotating shaft of an air-conditioning compressor, idler pulleys 6, 7, the motor generator pulley 2, and a tensioner pulley 3 that is fixed to a rotating shaft of an electric tensioner 30.

Tension that is applied to the belt 8 is adjusted when the electric tensioner 30 is controlled by the ECU 20. Various known aspects can be applied to the electric tensioner 30, and detailed description thereof will be omitted herein.

The engine 10 according to this embodiment is started when the engine 10 is cranked by a combustion torque that is generated through ignition of a fuel which is injected into a cylinder of the engine 10 in an expansion stroke and a motor torque that is output from the motor generator MG and transmitted to the crank pulley 1 via the belt 8 as necessary.

According to this configuration, the tension that is applied to the belt 8 can be more reduced than in a case where the engine 10 is cranked and started by the motor generator MG alone.

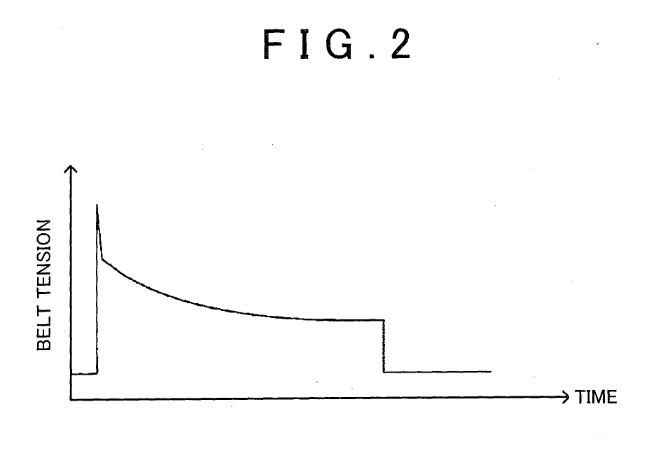

Specifically, the tension that is applied to the belt 8 rises rapidly during an initial cranking stage as illustrated in, for example, FIG. 2 in a case where the engine 10 is cranked by the motor generator MG alone. This is because inertia of the crank pulley 1 is very large and the tension of the belt 8 between the crank pulley 1 and the motor generator pulley 2 increases during the initial cranking stage.

However, the motor torque can be suppressed and thus the tension that is applied to the belt 8 can also be reduced in a case where the motor torque is used along with the combustion torque as in this embodiment.

In addition, the engine 10 can be started earlier and more reliably than in a case where the engine 10 is cranked and started by the motor generator MG alone after the start-up of the engine 10 by the combustion torque alone fails despite an ignition start-up attempt.

In addition to the above-described method for starting the engine 10, a starter motor may be further disposed so that the engine 10 is started by the starter motor as well. According to this configuration, the engine 10 can be started, without increasing the tension that is applied to the belt 8, in a case where ignition start-up is difficult. This is highly advantageous for practical purposes.

In order to start the engine 10 through ignition start-up, a crank stop position at a time when the engine 10 is stopped has to be adjusted to a position slightly advancing from, for example, a compression top dead center (TDC) (for example, 45° behind the compression TDC). With merely stopping of the engine 10, it is difficult to adjust the crank stop position to a target stop position.

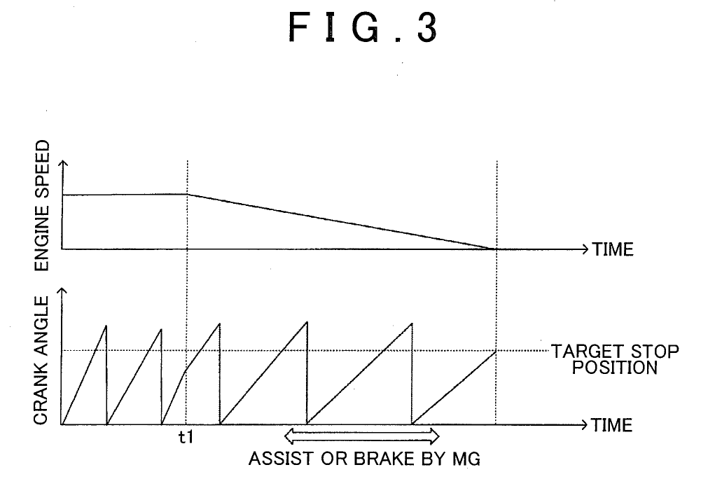

In this embodiment, the motor generator MG is controlled by the ECU 20, so that the crank stop position is adjusted to the target stop position, when the engine 10 is stopped. Specifically, the ECU 20 controls the motor generator MG, when stop processing is initiated on the engine 10 (refer to post-time t1 in FIG. 3), to accelerate rotation of the crankshaft by outputting power or decelerating the rotation of the crankshaft by using a regeneration brake.

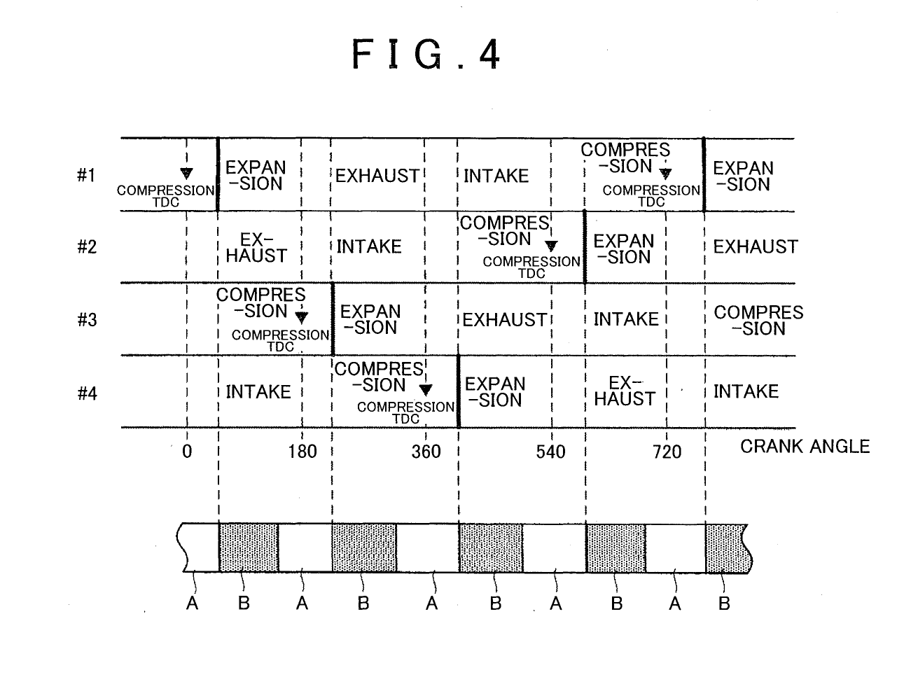

Control of the motor generator MG in a case where the engine 10 is a 4-cylinder engine will be described in detail with reference to FIG. 4. A crank angle that is illustrated by the thick line in FIG. 4 is the target stop position.

The ECU 20 estimates the crank stop position based on, for example, the speed of the engine 10. In a case where the estimated crank stop position is within a predetermined range advancing from the target stop position (within a range to which sign B is attached in the lower part of FIG. 4), the ECU 20 controls the motor generator MG so that the rotation of the crankshaft is decelerated through regeneration.

In a case where the estimated crank stop position is within a predetermined range ahead of the target stop position (within a range to which sign A is attached in the lower part of FIG. 4), the ECU 20 controls the motor generator MG so that power is output and the rotation of the crankshaft is accelerated.

If the crank stop position is the target stop position, the above-described control allows the engine 10 to be cranked by using the combustion torque during the subsequent start-up of the engine 10, and thus the engine 10 can be started quickly. In addition, the tension that is applied to the belt 8 during the start-up of the engine 10 can be reduced and friction can be reduced, and thus fuel economy can be improved.

However, the crank stop position may not be adjusted to the target stop position through the above-described control. In this case, the ECU 20 controls the motor generator MG after the engine 10 is stopped so that the crank stop position is adjusted to the target stop position. In this case, the ECU 20 controls the electric tensioner 30 so that the tension that is applied to the belt 8 is increased. This is to appropriately transmit the power that is output from the motor generator MG to the crank pulley 1 via the belt 8.

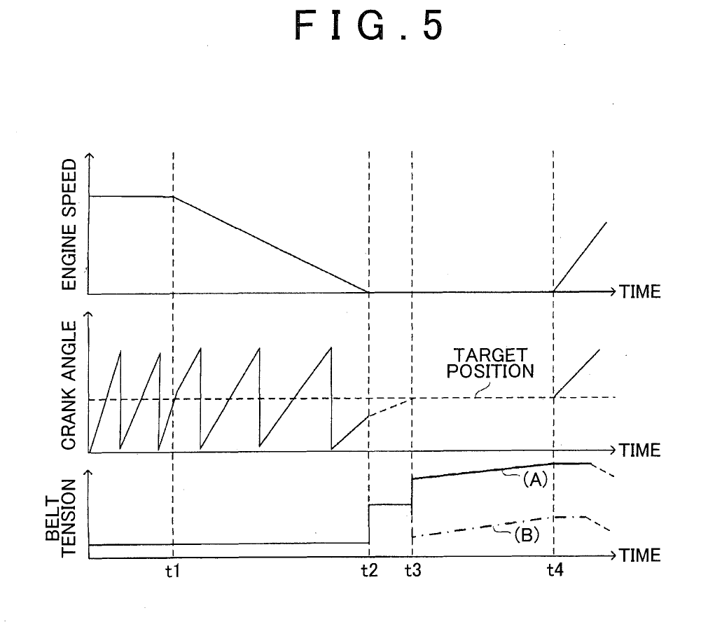

Specifically, the ECU 20 controls the electric tensioner 30 to increase the tension that is applied to the belt 8 and controls the motor generator MG to adjust the crank stop position to the target stop position in a case where the crank stop position is not the target stop position and a quick start-up of the engine 10 is required (refer to times t2 to t3 in FIG. 5).

Examples of the case where the quick start-up of the engine 10 is required include a case where the engine 10 that is stopped by a so-called idle stop mechanism is automatically re-started during hybrid vehicle start-up and a case where the engine 10 is started when the hybrid vehicle travels only with a driving force of the motor generator.

Even in a case where the ignition start-up of the engine 10 is attempted, explosion energy (that is, combustion torque) sufficient for the start-up of the engine 10 may not be obtained depending on, for example, an oil/water temperature, an atmospheric pressure, and the length of time elapsed from the stopping of the engine 10.

Particularly in this embodiment, the ECU 20 estimates the combustion torque relating to the ignition start-up and the motor torque relating to the motor generator MG after the ECU 20 controls the motor generator MG and the like (for example, refer to time t3 in FIG. 5) to adjust the crank stop position to the target stop position. Then, the ECU 20 controls the electric tensioner 30 to increase the tension that is applied to the belt 8, based on the estimated motor torque before the engine 10 is started, according to the estimated combustion torque so that torque that has to be transmitted to the engine 10 from the motor generator MG is transmitted via the belt 8.

Specifically, the ECU 20 controls the electric tensioner 30 to increase the tension that is applied to the belt 8 (for example, refer to solid line (A) in FIG. 5), so that the torque to compensate for a fuel torque shortfall is output from the motor generator MG and transmitted to the engine 10 via the belt 8, in a case where the estimated combustion torque is smaller than the torque required for the start-up of the engine 10 and the engine 10 cannot be started through the ignition start-up alone. According to this configuration, the engine 10 can be reliably started by combustion torque and the motor torque.

The ECU 20 controls the electric tensioner 30 so that the tension that is applied to the belt 8 is decreased compared to a case where the combustion torque is smaller than the torque required for the start-up of the engine 10 (for example, refer to one-dot chain line (B) in FIG. 5) in a case where the estimated combustion torque is larger than the torque required for the start-up of the engine 10 and the engine 10 can be started through the ignition start-up alone. According to this configuration, the friction during the ignition start-up of the engine 10 can be reduced and fuel economy can be improved.

In a case where the estimated combustion torque is equal or almost equal to the torque required for the start-up of the engine 10, the ECU 20 may control the electric tensioner 30 to change the tension that is applied to the belt 8 so that a predetermined torque is transmitted to the engine 10 from the motor generator MG via the belt 8 and the engine 10 is started with reliability. Alternatively, it may be determined whether or not to transmit the torque to the engine 10 from the motor generator MG via the belt 8 according to whether or not the estimated combustion torque reaches a torque which is larger than the torque required for the start-up of the engine 10 by a predetermined torque. Herein, the “predetermined torque” may be set based on, for example, an error relating to a sensor for detecting a physical quantity or a parameter required for the estimation of the combustion torque and an error relating to the estimation processing.

The belt tension increases during time t3 to time t4 in FIG. 5 (refer to solid line (A) and one-dot chain line (B)). This is because the combustion torque decreases with time.

The “ECU 20” according to this embodiment is an example of the “belt tension control device” and “control means” according to the invention. The “electric tensioner 30” according to this embodiment is an example of “tension changing means” according to the invention.

### Modification Example

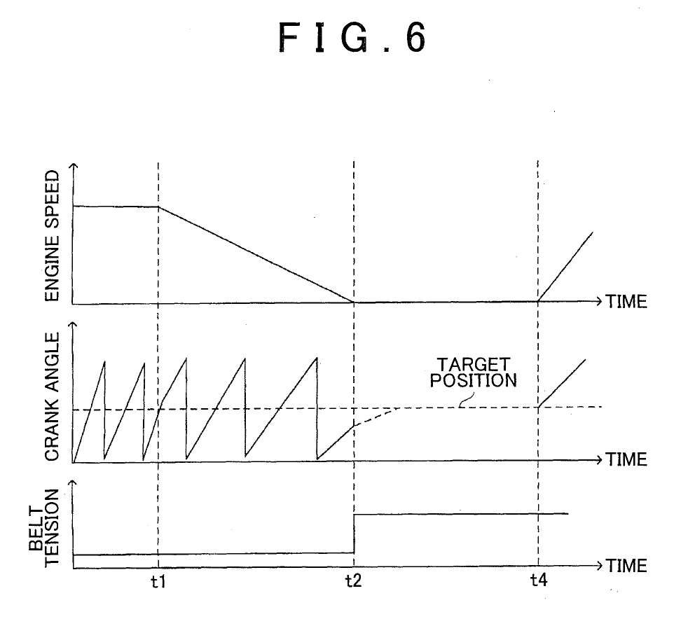

A modification example of the belt tension control device according to this embodiment will be described with reference to FIG. 6. FIG. 6 is a diagram illustrating time-dependent change in belt tension according to the modification example of the embodiment along with time-dependent change in engine speed and crank angle.

In the modification example, the ECU 20 as an example of the “belt tension control device” according to the invention controls the electric tensioner 30 so that the tension that is applied to the belt 8, which is increased at time t2 in FIG. 6, is maintained in preparation for the subsequent start-up of the engine 10.

According to this configuration, a combustion torque shortfall can be compensated for, with relative ease, by the motor generator MG during the subsequent start-up of the engine 10 (time t4 in FIG. 6) even in a case where the combustion torque does not reach the torque required for the start-up of the engine 10. The friction can be suppressed and fuel economy can be improved even in a case where the engine 10 can be started by the combustion torque alone.

The invention is not limited to the embodiment described above, and can be appropriately changed within the range of the scope and spirit of the invention described in the claims and the entire specification. Any belt tension control device according to such a change is included in the technical scope of the invention.

1. A control device for a hybrid vehicle, the hybrid vehicle including an engine, a motor, a belt configured to transmit power between the engine and the motor, and a tension changing device configured to change tension applied to the belt, and the hybrid vehicle being configured to start the engine through ignition of the engine and the hybrid vehicle being configured to start the engine by the motor, the control device comprising:
an electronic control unit configured to estimate a combustion torque relating to the ignition of the engine and a motor torque relating to the motor before the engine is started, and
the electronic control unit being configured to change the tension applied to the belt based on an estimated motor torque before the engine is started such that a torque to be transmitted to the engine from the motor is transmitted via the belt according to an estimated combustion torque.

2. The control device according to claim 1,
wherein the electronic control unit is configured to change the tension applied to the belt based on the estimated motor torque before the engine is started when the estimated combustion torque is smaller than a torque required to start the engine such that a sum of the estimated combustion torque and a torque transmitted to the engine from the motor via the belt is equal to or larger than a required torque.

3. The control device according to claim 1,
wherein the electronic control unit is configured to control the tension changing device before the engine is started such that a tension applied to the belt when the estimated combustion torque is larger than a torque required to start the engine is smaller than a tension applied to the belt when the estimated combustion torque is smaller than the torque required to start the engine.

4. The control device according to claim 2,
wherein the electronic control unit is configured to control the tension changing device before the engine is started such that a tension applied to the belt when the estimated combustion torque is larger than a torque required to start the engine is smaller than a tension applied to the belt when the estimated combustion torque is smaller than the torque required to start the engine.
